(19) United States
(12) Patent Application Publication
(10) Pub. No.: US 2014/0026793 A1
(43) Pub. Date: Jan. 30, 2014

(54) Hopper And Meter Mount for Agricultural Planter

(71) Applicant: Chad Alan Baker, Orangeville, IL (US)

(72) Inventor: Chad Alan Baker, Orangeville, IL (US)

(21) Appl. No.: 13/792,568

(22) Filed: Mar. 11, 2013

Related U.S. Application Data
(60) Provisional application No. 61/675,152, filed on Jul. 24, 2012.

(51) Int. Cl. A01C 7/04

(52) U.S. Cl. CPC A01C 7/04; A01C 7/046
USPC 111/185; 111/184; 111/14

(57) ABSTRACT

A seed planting apparatus comprises a meter configured to meter agricultural seeds, a meter drive connected to the meter, a drive gear connected to the meter via the meter drive and configured to rotate the meter based on rotational motion imparted to the drive gear, and a hopper, which comprises a hopper body, a seed port connectable to a seed supply, and a meter port connectable to the meter.

### REFERENCE TO RELATED APPLICATION

This application claims the benefit of U.S. Provisional Patent Application No. 61/675,152, filed Jul. 24, 2012, entitled “MINI HOPPER AND MOUNTING BRACKET FOR A CORN PLANTER.”

### BACKGROUND OF THE INVENTION

The present invention relates to a corn planter and, more particularly, to a mini hopper and meter for a corn planter.

Case IH™ corn planter meters have a severe issue with seed spacing and seed metering. The main issue is that Case™ corn meters are designed in such a way that no modifications can be done to improve the performance of the existing meter. The Case IH™ corn meters do a poor job of delivery and placement of seed. Therefore, there is a need for a more precise meter to enable more accurate metering of seed corn and other seeds.

As can be seen, there is a need for solutions to these and other problems.

### SUMMARY OF THE INVENTION

In one aspect of the present invention, a seed planting apparatus comprises: a meter configured to meter agricultural seeds; a meter drive connected to the meter; a drive gear connected to the meter via the meter drive and configured to rotate the meter based on rotational motion imparted to the drive gear; and a hopper comprising: a hopper body; a seed port connectable to a seed supply; and a meter port connectable to the meter.

In one aspect, the seed planting apparatus further comprises a meter drive adapter connected between the drive gear and the meter drive and configured to connect the meter to the drive gear. In one aspect, the seed planting apparatus further comprises corn seeds located inside the hopper.

In one aspect, the hopper further comprises a mounting bracket connected to the hopper body and configured to mount to a planting row unit. In one aspect, the hopper body comprises a plurality of air holes located proximal to the seed port and configured to regulate transfer of seeds from the seed supply to the hopper.

In one aspect, a method of modifying a seed planting apparatus comprises: providing a planting row unit comprising: a first meter configured to meter agricultural seeds; a drive gear connected to the first meter and configured to rotate the first meter based on rotational motion imparted to the drive gear; and a drive chain connected to the drive gear; removing the first meter; providing a second meter and connecting the second meter to the drive gear so that the drive gear is configured to rotate the second meter based on rotational motion imparted to the drive gear; providing a hopper comprising: a hopper body; a seed port connectable to a seed supply; and a meter port connectable to the second meter; and connecting the hopper to the planting row unit so that seeds in the hopper body are fed to the second meter via the meter port.

In one aspect, the method further comprises providing a meter drive adapter and connecting the drive meter adapter between the drive gear and the second meter. In one aspect, the method further comprises providing corn seeds in the hopper body via the seed port and distributing the corn seeds by rotating the second meter.

In one aspect, the first meter and the second meter are configured to meter seeds at a different rate. In one aspect, the hopper further comprises a mounting bracket and the method further comprises connecting the hopper to the planting row unit via the mounting bracket.

These and other features, aspects and advantages of the present invention will become better understood with reference to the following drawings, description and claims.

### BRIEF DESCRIPTION OF THE DRAWINGS

FIG. 1: is a perspective view of one embodiment of the invention illustrated with item 20 cover in place.

FIG. 2: is a perspective view of one embodiment of the invention illustrated without item 20 cover in place.

FIG. 3: is a right perspective view of one embodiment of the invention.

FIG. 4: is a left perspective view of one embodiment of the invention.

FIG. 5: is a front view of one embodiment of the invention.

FIG. 6: is a top view of one embodiment of the invention.

FIG. 7: is a side view of one embodiment of the invention.

FIG. 8: is a bottom view of one embodiment of the invention illustrating interface with meter 24.

FIG. 9: is a section detail view of one embodiment of the invention along line 9-9 in FIG. 2, illustrated in use with exemplary seed 34.

FIG. 10: is a perspective detail exploded view of one embodiment of the invention illustrating drive adaptor 42.

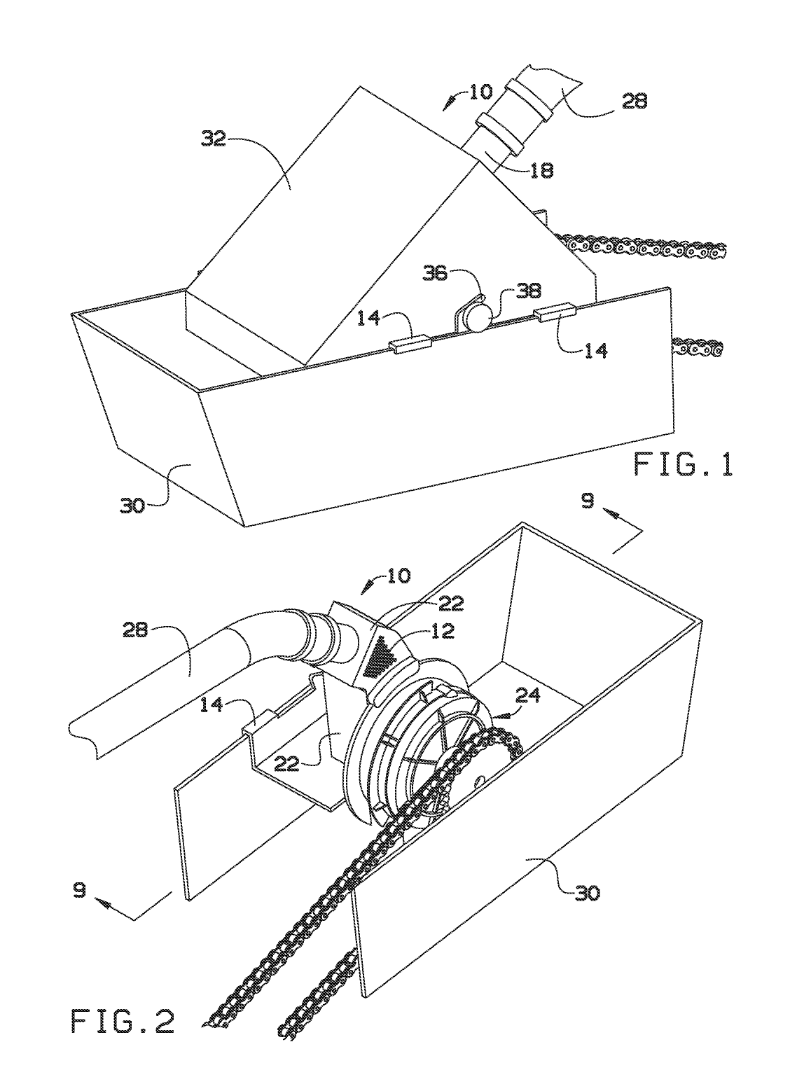

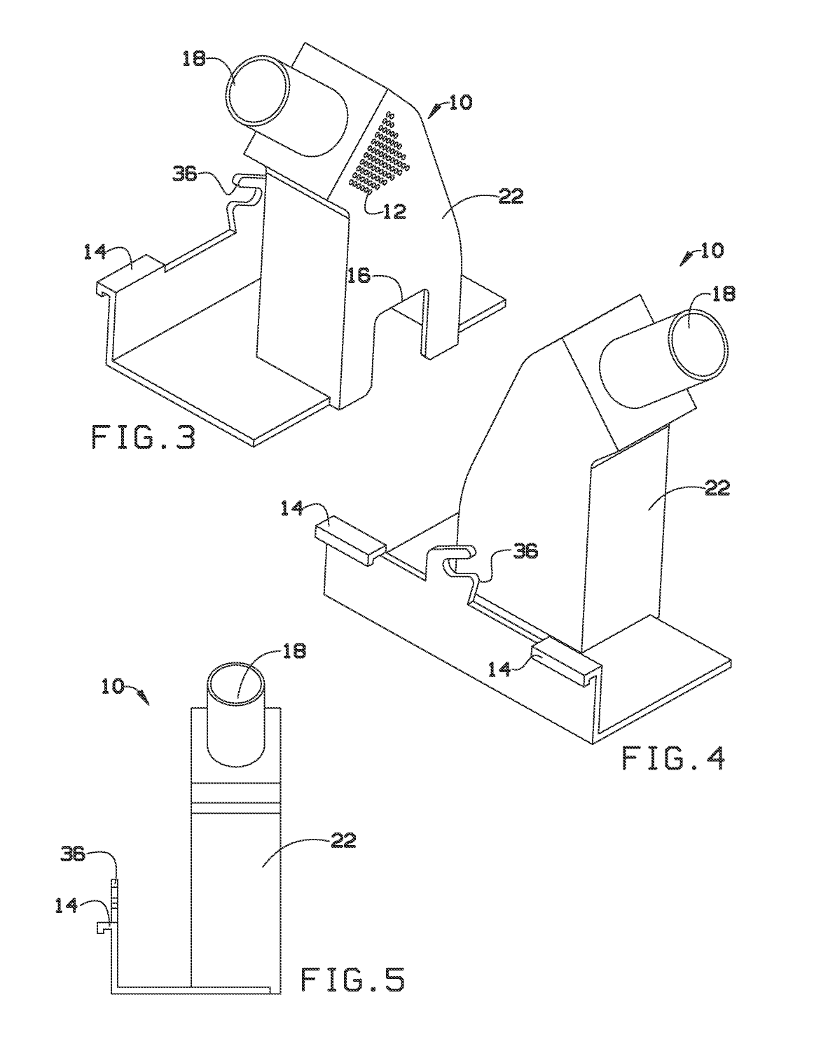

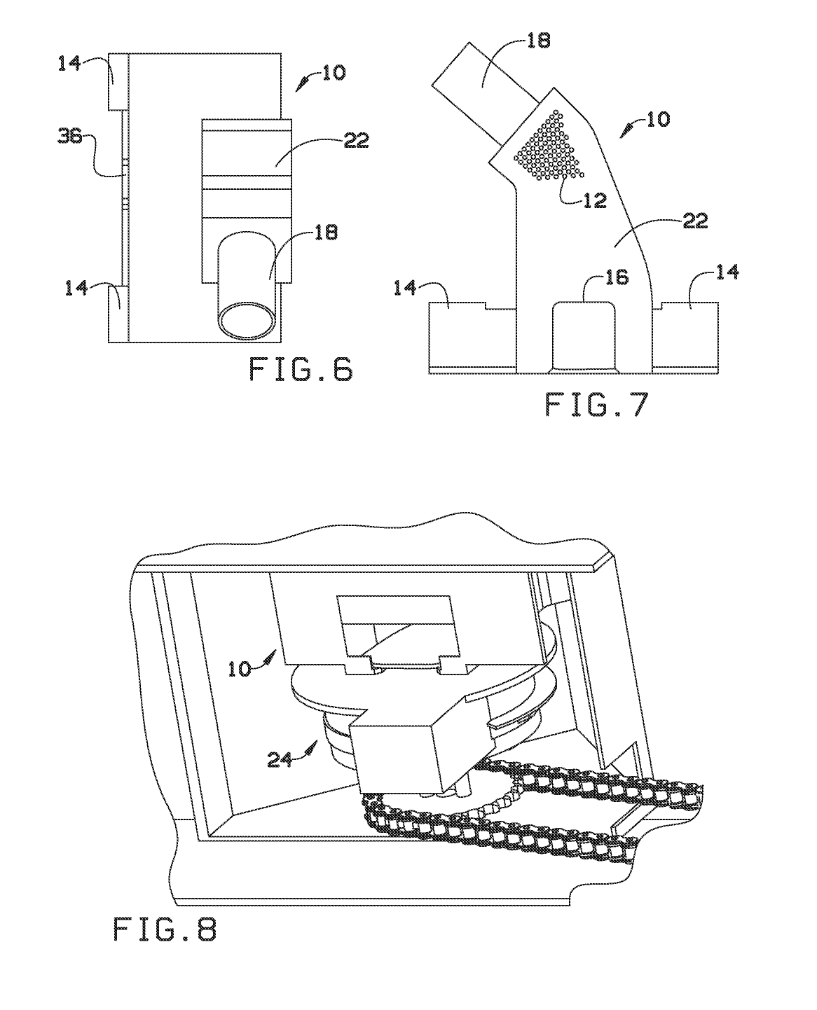

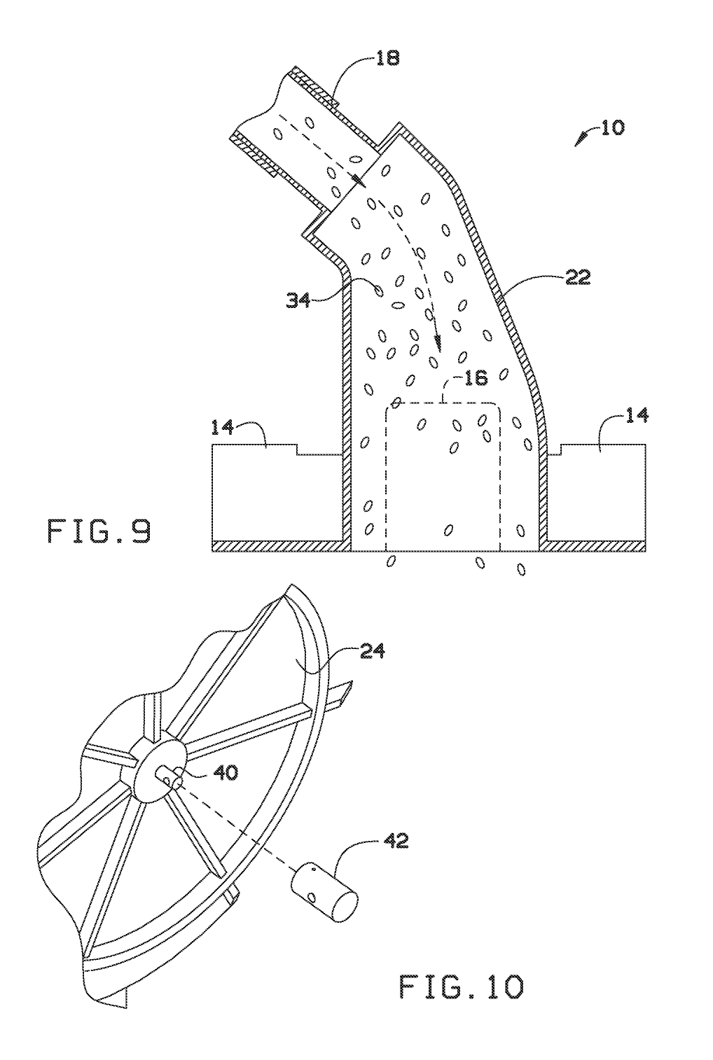

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an embodiment of the present invention provides a system for improving a seed planter or a corn planter with a mini hopper and a mounting bracket.

Referring now to the figures, the following reference numbers may refer to elements of the invention:

10: is the mini hopper unit.

12: are the air holes.

14: is the hook.

16: is the meter port.

18: is the seed port.

22: is the hopper body.

24: is the meter.

28: is the hose.

30: is the planting row unit.

32: is the cover.

34: is the exemplary seed.

36: is the lid mount bracket.

38: is the lid mount fastener.

40: is the meter drive.

42: is the meter drive adaptor.

44: is the drive gear/pulley.

46: is the drive chain/belt.

In one aspect of the present invention, a mounting bracket is bolted to the row unit of the corn planter using existing holes. A mini hopper is then connected to the mounting bracket by screws. The mini hopper acts as a storage and funnel for seed corn to be delivered to the corn meter. A drive adapter bushing is then connected to the new planter meter to allow for the mating of the butterfly drive (which may be made by Case™) to be mounted to drive the unit.

An embodiment of making the invention is described below, although materials, sizes, shapes, and dimensions may vary as desired, and the present invention is not limited to the embodiments disclosed. In one embodiment of the invention, the invention may be made by procuring a 4″ by 3″ angle aluminum and plastic, although the present invention is not limited by these cited measurements or materials or any other measurements or materials cited herein. The mounting bracket is cut from angle aluminum at a length of 10″ and two 1.5″ by 0.5″ angle tabs may be welded on to the top of the 10″ angle aluminum. Next, a 2.5″ by 1.25″ section may be cut from the 4″ side of the angle. With the 4″ side of the angle flat on a bench, measure from the left side a 5″ and mark, and a mark from the right side at 2.5″. Now, measuring in from the edge and using the 5″ mark as a referenced starting point, measure back 1.25″ and mark, using a straight edge, to join these two marks. Next, measuring in from the edge using the 2.5″ mark as a referenced starting point, measure back 1.25″ and mark, using a straight edge, to join these two marks. Next, use the straight edge to join the two 1.25″ marks together to make a complete box. Finally, using a cutter, cut along these lines.

Seven holes may now be drilled into the angle aluminum. All of the holes may be drilled with a ⅜″ drill bit. The first hole may be drilled on the 3″ side of the aluminum approximately 1.5″ down and 5.25″ across. The final six holes may all be drilled on the 4″ side of the angle aluminum. Each step to follow may be carried out with the 4″ side of the angle laying flat on a bench with the 3″ side up. The first hole may be measured from the right side of the angle. This hole may be drilled approximately 0.75″ in and 1″ back. The next hole may be measured from the left side of the angle. This hole may be drilled approximately 1.5″ in and 1″ back. The last four holes may be drilled using the 2.5″ by 1.25″ cut out as a measure reference. From the inside of the cut out, measure to the left 0.75″ and mark, from the edge measure 0.25″ and mark, then drill. Next, measure 0.75″ in again and mark, from the edge measure in 1.5″ and mark, then drill. Now from the right side measure a 0.75″ mark, and measure in from the edge 0.25″ and mark, then drill. Finally, measure a 0.75″ and mark, then measure in from the edge 1.5″ and mark, then drill. Now the angle aluminum is done.

In an embodiment of the invention, the bushing adapter may be cut from a ⅝″ solid steel rod at 0.687″ long. A 0.25″ hole may now be drilled down the center of the rod. Next, two holes may be drilled in the ⅝″ rod along the 0.687″ side. The first hole may be drilled approximately 0.170″ in from the edge using a 0.101″ drill bit. The final hole may be drilled using the same end as a reference point, measure in 0.437″ in and using a 0.187″ drill bit.

In another embodiment of the invention, the plastic molding hopper may be mounted to the 3″ by 4″ angle aluminum using the four holes around the 1.25″ by 2.5″ cut out on the 4″ side. A more precise corn meter may be mounted to the angle using the two holes on the very edge of the 4″ side of the angle. The bushing adapter may now be installed on the drive shaft of the corn meter to adapt the CNH butterfly drive. The complete hopper kit may be mounted to the existing holes on the corn planter row unit using the single hole on the 3″ side of the angle aluminum. Finally, in this embodiment, the tabs may be set down to fit to the edge of the unit to lock the system firmly in place.

The invention allows for a more advanced corn meter to be mounted to a Case™ planter to allow for more accurate and precise seeding. This allows for a grower to mount a more precise meter to their Case IH™ corn planter for a more accurate metering system. This invention allows for a more advanced, more precise metering system to be installed in place of the Case™ meter. The Case™ system releases the seed in such a way that it allows for poor spacing by the time it hits the ground.

In one aspect of the present invention, a seed planting apparatus includes: a mounting bracket; plastic mini hopper; and drive adapter bushing. The mounting bracket is the base of the system, which may be then bolted to the row unit of a corn planter. The mini hopper is then connected to the mounting bracket and is used as a funnel for storage of seed for the corn meter. The drive adapter bushing is used to adapt a larger drive on to the smaller shaft of the corn meter. It is then used to drive the corn meter.

In making an embodiment of the present invention, the mini hopper may first be molded out of plastic material. The mounting bracket may next be cut out of angle aluminum. Three holes may now be drilled. The first hole may be drilled on the side to mount the bracket to the row unit. The next two holes may be drilled to mount the more precise corn meter to the mounting bracket. Finally, the drive adaptor may be cut out of hard stock round metal rod. Then three holes may be drilled into the drive adapter so it can be properly mounted to the corn meter and allow for the CNH drive to adapt to the corn meter.

In one aspect of the present invention, a seed planting apparatus comprises: a meter 24 configured to meter agricultural seeds; a meter drive 40 connected to the meter 24; a drive gear 44 connected to the meter 24 via the meter drive 40 and configured to rotate the meter 24 based on rotational motion imparted to the drive gear 44; and a hopper 10 comprising: a hopper body 22; a seed port 18 connectable to a seed supply (such as hose 28); and a meter port 16 connectable to the meter 24.

In one aspect, the seed planting apparatus further comprises a meter drive adapter 42 connected between the drive gear 44 and the meter drive 40 and configured to connect the meter 24 to the drive gear 44. The adapter 42 may vary in size, allowing a user to adapt a wide variety of planting row units 30, and may be connectable in any way known (such as a tightening screw, etc.). In one aspect, the seed planting apparatus further comprises corn seeds 34 (or any other seeds) located inside the hopper 10.

In one aspect, the hopper further comprises a mounting bracket 36 connected to the hopper body 22 and configured to mount to a planting row unit 30. In one aspect, the hopper body 22 comprises a plurality of air holes 12 located proximal to the seed port 18 and configured to regulate transfer of seeds from the seed supply to the hopper 10.

In one aspect, a method of modifying a seed planting apparatus comprises: providing a planting row unit 30 comprising: a first meter (which may be shown as meter 24 in the drawings) configured to meter agricultural seeds 34; a drive gear or pulley 44 connected to the first meter and configured to rotate the first meter based on rotational motion imparted to the drive gear or pulley 44; and a drive chain or belt 46 connected to the drive gear or pulley 44; removing the first meter; providing a second meter (which may be shown as meter 24 in the drawings, but may have a different size, shape, level of precision, level of accuracy, material composition, etc.) and connecting the second meter to the drive gear 44 so that the drive gear 44 is configured to rotate the second meter based on rotational motion imparted to the drive gear 44; providing a hopper 10 comprising: a hopper body 22; a seed port 18 connectable to a seed supply; and a meter port 16 connectable to the second meter; and connecting the hopper 10 to the planting row unit 30 so that seeds 34 in the hopper body 22 are fed to the second meter via the meter port 16.

In one aspect, the method further comprises providing a meter drive adapter 42 and connecting the meter drive adapter 42 between the drive gear 44 and the second meter. In one aspect, the method further comprises providing corn seeds 34 (or any other seeds) in the hopper body 22 via the seed port 18 and distributing the corn seeds by rotating the second meter.

In one aspect, the first meter and the second meter are configured to meter seeds at a different rate. In one aspect, the hopper further comprises a mounting bracket 38 and the method further comprises connecting the hopper 10 to the planting row unit 30 via the mounting bracket 38.

It should be understood, of course, that the foregoing relates to exemplary embodiments of the invention and that modifications may be made without departing from the spirit and scope of the invention.

What is claimed is:

1. A seed planting apparatus, comprising:
a meter configured to meter agricultural seeds;
a meter drive connected to the meter;
a drive gear connected to the meter via the meter drive and configured to rotate the meter based on rotational motion imparted to the drive gear; and
a hopper comprising:
a hopper body;
a seed port connectable to a seed supply; and
a meter port connectable to the meter.

2. The seed planting apparatus as claimed in claim 1, further comprising a meter drive adapter connected between the drive gear and the meter drive and configured to connect the meter to the drive gear.

3. The seed planting apparatus as claimed in claim 1, further comprising corn seeds located inside the hopper.

4. The seed planting apparatus as claimed in claim 1, wherein the hopper further comprises a mounting bracket connected to the hopper body and configured to mount to a planting row unit.

5. The seed planting apparatus as claimed in claim 1, wherein the hopper body comprises a plurality of air holes located proximal to the seed port and configured to regulate transfer of seeds from the seed supply to the hopper.

6. A method of modifying a seed planting apparatus, comprising:
providing a planting row unit comprising:
a first meter configured to meter agricultural seeds;
a drive gear connected to the first meter and configured to rotate the first meter based on rotational motion imparted to the drive gear; and
a drive chain connected to the drive gear;
removing the first meter;
providing a second meter and connecting the second meter to the drive gear so that the drive gear is configured to rotate the second meter based on rotational motion imparted to the drive gear;
providing a hopper comprising:
a hopper body;
a seed port connectable to a seed supply; and
a meter port connectable to the second meter; and
connecting the hopper to the planting row unit so that seeds in the hopper body are fed to the second meter via the meter port.

7. The method as claimed in claim 6, further comprising providing a meter drive adapter and connecting the meter drive adapter between the drive gear and the second meter.

8. The method as claimed in claim 6, wherein the first meter and the second meter are configured to meter seeds at a different rate.

9. The method as claimed in claim 6, further comprising providing corn seeds in the hopper body via the seed port and distributing the corn seeds by rotating the second meter.

10. The method as claimed in claim 6, wherein the hopper further comprises a mounting bracket and the method further comprises connecting the hopper to the planting row unit via the mounting bracket.
